(19) United States
(12) Patent Application Publication
(10) Pub. No.: US 2022/0030886 A1
(43) Pub. Date: Feb. 3, 2022

(54) FORTIFIED DOUGH FOR GASTRONOMIC FOOD, FOOD, AND METHOD

(71) Applicants: Luca BARBIERI, Brescia (IT); Alessandro MACCA, Brescia (IT); Fabrizio MURATORI, Varese (IT); Federico VIGNATI, Milano (IT); Gianleone DI SACCO, Milano (IT)

(72) Inventors: Luca BARBIERI, Brescia (IT); Alessandro MACCA, Brescia (IT); Fabrizio MURATORI, Varese (IT); Federico VIGNATI, Milano (IT); Gianleone DI SACCO, Milano (IT)

(21) Appl. No.: 17/278,737

(22) PCT Filed: Sep. 20, 2019
(86) PCT No.: PCT/IB2019/057986

§ 371 Date: Mar. 23, 2021

(30) Foreign Application Priority Data
Sep. 24, 2018 (IT) 102018000008859

(51) Int. Cl. A21D 2/24; A21D 13/066; A21D 2/16; A21D 13/80; A21D 13/41; A21D 13/43; A21D 8/04

(52) U.S. Cl. CPC A21D 2/245; A21D 13/066; A21D 2/165; A21D 8/045; A21D 13/41; A21D 13/43; A21D 13/80

(57) ABSTRACT

A method for preparing a fortified gastronomic composite food is provided. The method includes, in the following order, working hen eggs in a kneader with sugar and a mixture of at least one essential amino acid and at least one non-essential amino acid or conditionally essential amino acid, adding edible oil or fat, adding flour and dietary fibers at the same time, adding flavoring and leavening agents, mixing a dough to obtain a smooth, compact and homogeneous dough, and baking the dough in an oven. A dough for making a fortified gastronomic composite food including cereal flour, dietary fibers, at least one edible oil or fat, at least one egg, at least one essential amino acid and at least one non-essential or conditionally essential amino acid is also provided.

The present invention relates to an edible dough. Furthermore, it is an object of the present invention a method for making such a dough and the relative fortified gastronomic food obtainable with such a dough; in particular, pasta or bakery products, such as pasta, bread, pizza, biscuits and the like.

It is known that from an age of about 45 years, there is a progressive and physiological decrease in muscle mass due to a natural reduction in muscle protein synthesis and/or to a loss and disorganization of myofilaments. In some cases, the consequences of this loss are so important as to constitute a real pathology known as sarcopenia, responsible for the main causes of weakness and disability in the elderly.

To compensate for this loss, over the years protein or high protein diets have been developed to try to counter this deficiency. However, proteins have the drawback of determining an increased nitrogen load for the kidney, with the consequent risk of compromising renal function, especially in the elderly subject.

A possible alternative to the administration of high-protein diets is represented by the oral administration of amino acids, which are the constitutive units of proteins.

To date, in an inappropriate manner, the intake of amino acids occurs in a medicalized manner, that is, by means of sachets whose content is administered orally. Given the strongly bitter taste of amino acids, the content of the sachets is also strongly sweetened, thus limiting the intake in particular types of subjects.

Disadvantageously, the medicalized intake of the amino acids does not allow an effective control on the doses assumed by a subject, above all in relation to the type of daily diet followed by the subject.

In the international patent application PCT/IB2018/051983 on behalf of the same applicants of the present application, the inventors have proposed a solution to the aforementioned drawbacks, by means of a dough and a method of making the dough capable of obviating a medicalized assumption of the amino acids and of masking the bitter taste thereof.

One of the objects of the present invention is to improve the taste of the dough enriched with amino acids described in the previous patent application, with the same ingredients introduced. Morever, an object of the present invention is to ensure an equal or improved bioavailability and medical efficacy of the dough.

Such an object is achieved by a dough, by a method of making the dough, by a fortified gastronomic composite food, by a pastry or bakery product and by a method of preparing a fortified gastronomic composite food according to the appended independent claims. The dependent claims describe embodiment variations.

The features and the advantages of present invention will appear more clearly from the following description, made by way of an indicative and non-limiting example.

The dough according to the present invention is particularly suitable for the production of a gastronomic composite food, for example a pastry product or a bakery product, such as, among others, pasta, ravioli, gnocchi, bread, pizza, focaccia, biscuits and the like. The dough comprises a cereal flour, with or without gluten, and one or more (i.e. a mix) of the essential amino acids, preferably one or more of the essential amino acids selected from the group comprising L-leucine, L-lysine, L-isoleucine, L-valine, L-threonine, L-cysteine, L-histidine, L-phenylalanine, L-methionine, L-tyrosine, L-tryptophan.

In other words, the essential amino acid is added to the cereal flour. For example, the essential amino acid is added in its isolated form (e.g. in the form of zwitterion), preferably in the form of an aqueous solution or in the form of crystalline powder or the like.

Therefore, the present invention also relates to the use of an isolated amino acid or a mixture of isolated amino acids, preferably a mixture of isolated essential amino acids, for preparing a dough for making a fortified food product.

Therefore, it is contemplated to use the isolated amino acid or the mixture of isolated amino acids to add them to the cereal flour, with the aim of obtaining a dough thereof.

The word “cereal” is to be understood in the broadest sense of the word. For example, any plant or plant product whose fruit or starch-rich seeds are used by man for obtaining starchy products, such as polenta, soups, bread, pasta to be cooked, and the like, is to be understood as a cereal. Therefore, corn, rice, wheat (soft wheat, durum wheat, spelt, etc.), barley, sorghum, millet, oats, triticale, rye, buckwheat, fonio, quinoa and the like are to be considered cereals.

Preferably, the dough also comprises thiamine and/or pyridoxine.

In addition, preferably, the dough comprises at least one of the essential amino acids selected from the group comprising L-leucine, L-lysine, L-isoleucine, L-valine, L-histidine, L-phenylalanine, L-methionine, L-tyrosine, L-tryptophan and at least one non-essential or conditionally essential amino acid selected from the group comprising: arginine, citrulline, ornithine, cysteine, glutamine, glycine, serine, proline, taurine and tyrosine.

The dough comprises at least one of the essential amino acids, preferably selected from the group comprising L-leucine, L-lysine, L-isoleucine, L-valine, L-histidine, L-phenylalanine, L-methionine, L-tyrosine, L-tryptophan, L-threonine and at least one non-essential amino acid, preferably a non-essential amino acid selected from the group comprising: alanine, aspartic acid, asparagine, glutamic acid.

Preferably, the dough comprises both a conditionally essential amino acid and a non-essential amino acid, for example selected from the groups indicated in the preceding paragraphs.

I n other words, one or more non-essential or conditionally essential amino acids are additionally added to the cereal flours.

In a non-limiting way, in addition to the flour and at least one of the essential amino acids, the dough may comprise ingredients suitable to give a particular mechanical and organoleptic consistency for the correct achievement of a desired final foodstuff (for example, water, salts, any yeasts, eggs and the like).

According to advantageous variants of the dough, the amino acid content (intended as the total amount of all the amino acids present) is equal to at least 4% or, even more preferably, to at least 8% by weight, with respect to the total weight of the dough.

Preferably, the content of the essential amino acids is equal to at least 4% or, even more preferably, to at least 8% by weight, with respect to the total weight of the dough.

In a particularly advantageous variant of the dough, the amino acid content (intended as the total amount of all the amino acids present) is less than or equal to 15 g per 100 g of final product. In other words, the percentage by weight of amino acids is less than or equal to 15% with respect to the total weight of the dough. Such a content of amino acids allows to obtain a dough with an adequate compromise between nutritional effects (both therapeutic and preventive) and organoleptic effects linked to taste (mainly to the non-perception of the bitter taste of the amino acids).

In the remainder of the present description, where ranges of values are indicated (e.g., percentages by weight), the extremes of these ranges are to be considered included.

In particular, an embodiment variant of the dough having an amino acid content of between 7% and 9% by weight (preferably 8% by weight) with respect to the total weight of the dough proved to be particularly effective.

Preferably, the content of each of the amino acids L-threonine, L-cysteine, L-histidine, L-phenylalanine, L-methionine, L-tyrosine, L-tryptophan is between 0.1% and 15% by weight with respect to the total weight of the dough. If there is a mixture of two or more of the amino acids L-threonine, L-cysteine, L-histidine, L-phenylalanine, L-methionine, L-tyrosine, L-tryptophan, the percentage by weight of this mixture is between 0.1% and 15% and is intended as the total sum of the percentages by weight of each of the aforesaid amino acids that make up the mixture.

In an advantageous embodiment, if there is a mixture of two or more of the essential amino acids, the percentage by weight of at least one of the essential amino acids is between 17% and 23% by weight with respect to the total weight of the mixture of the essential amino acids. In particular, preferably, the percentage by weight of leucine in the amino acid mixture is between 20% and 22% by weight with respect to the total weight of the mixture of the essential amino acids.

In a preferred embodiment, the dough comprises a mixture of all the essential amino acids L-leucine, L-lysine, L-isoleucine, L-valine, L-threonine, L-histidine, L-phenylalanine, L-methionine, L-tyrosine, L-tryptophan (hereinafter referred to as Mixture A). Such a mixture a may also include L-cysteine.

In this variant (Mixture A), preferably, the percentage by weight of the mixture of amino acids is between 5% and 15%, to obtain a product with a high biological value.

In a further embodiment of the mixture, in addition to the essential amino acids, the amino acid mixture comprises at least one conditionally essential or non-essential amino acid, preferably a conditionally essential or non-essential amino acid selected from the group comprising arginine, citrulline, ornithine, cysteine, glutamine, glycine, serine, proline, taurine, tyrosine, alanine, aspartic acid, asparagine, glutamic acid, threonine. This allows to obtain a nutritional versatility of the mixture where, due to the lack of synthesis, there is a need for other amino acids besides the essential ones. Preferably, in this embodiment, the dough comprises a mixture of all the following amino acids: cysteine, alanine, arginine, aspartic acid, glutamine, glycine, proline and serine (hereinafter Mixture B).

Preferably, the content of each of the amino acids of the group comprising cysteine, alanine, arginine, aspartic acid, glutamine, glycine, proline, serine is between 0.1% and 15% by weight with respect to the total weight of the dough. If there is a mixture of two or more non-essential amino acids, or preferably a mixture of two or more amino acids selected from the group comprising cysteine, alanine, arginine, aspartic acid, glutamine, glycine, proline, serine, the percentage by weight between 0.1% and 15% is to be understood as a total sum of the percentages by weight of each of the aforesaid amino acids that make up the mixture, so as to ensure therapeutic efficacy and gustatory pleasantness.

Preferably, the mixture of amino acids (mixture A or mixture B, or any other mixture) also comprises Thiamine and/or Pyridoxine, each in an amount of 10 mg per 100 g of dough.

The inventors have verified that a dough which in addition to comprising at least one essential amino acid and at least one non-essential amino acid or a conditionally essential amino acid, in the quantities and methods described above, if made predominantly or essentially from corn flour, dietary fiber, at least one fat or edible oil and possibly at least one egg, allows adequate masking of the bitter taste of amino acids and ensuring adequate bioavailability. By dough essentially made with corn flour, dietary fibers, at least one fat or edible oil and at least one egg it is meant that the sum of the quantities of corn flour, dietary fiber, at least one fat or edible oil, at least one egg, is equal to a percentage by weight of at least 50% of the total weight of the dough, or, preferably at least 70% of the total weight of the dough or even more preferably at least equal to 80% by weight of the total weight of the dough. Such a quantity of the above ingredients ensures adequate masking of the bitter taste of the amino acids and at the same time ensures an adequate bioavailability.

The dough made according to the present invention preferably comprises wheat flour, dietary fiber and/or wheat, eggs, butter, and one or more of the following ingredients: sugar, fructose and erythritol mixture, agave syrup, honey, sweeteners, maltitol, glucose syrup, malt extract, oil of various seeds, olive oil, extra virgin olive oil, palm oil, vanilla, dark chocolate, leavening agents.

The aforesaid components are suitably mixed together with the amino acids according to the final gastronomic product (foodstuff) to be produced.

In one embodiment, the dough comprises medium-chain triglycerides. For example, medium-chain triglycerides are added to the mixture of cereal flour and at least one of the essential amino acids. Preferably, the medium-chain triglycerides are added in a quantity ranging from 1.5 grams to 3.3 grams per 100 grams of dough, ends included. In particular, preferably the medium-chain triglycerides amount is equal to 3.3 grams per 100 grams of dough. In this way a particularly useful synergic effect is obtained due to the intake of a food comprising essential amino acids also in subjects suffering from hyposecretory pancreatitis.

By food (or dietary) fibers we mean for example the fibers derived from wheat, or from oats, from corn, from acacia, from bamboo, from guar, from apple, potato, from polysaccharide compounds of non-starch origin and the like. In particular, dietary fibers of a soluble or insoluble type, for example one or more of the following dietary fibers: lignin, cellulose, hemicellulose, beta-glucans, inulin, oligofructose, fructooligosaccharides, pectin, glucomannan, polydextrose, polyols, resistant dextrins, starch resistant, phenolic esters, cutin, gums, mucilages, or from compounds that variously combine these different types of fibers, or as the sum of different polysaccharides of even non-starch and lignin origin, and which will be hereinafter referred to as food or dietary fibers.

In a particularly advantageous variant, the dough comprises dietary fibers, for example dietary fibers with and without gluten, in a percentage between 2% and 20% by weight with respect to the total weight of the dough, even more preferably between 4% and 15% by weight.

Furthermore, preferably, the dough comprises food flavorings, for example one or more of the following flavorings: butter, vanilla, cocoa, citrus, fruit in general. Food flavorings are preferably present in an amount of between 1 g and 15 g per kilogram of final dough, even more preferably between 3 g and 9 g per kilogram of final dough.

The above percentages of dietary fibers together with the percentages of amino acids indicated above, and preferably also the percentages of natural flavors mentioned above, allow the incorporation of the amino acids in the dough and at least partially to more effectively neutralize the bitter taste of the amino acids.

The method for producing the fortified gastronomic composite food comprises a cooking step, in which the cooking temperature is between 145° and 190°, preferably between 150° and 240°, and even more preferably it is equal to 180°, preferably for 20-30 minutes in relation to the dough volumes and the thickness of the food before cooking.

Below are some recipes and some procedures for making dough variants according to the present invention intended to obtain corresponding food products.

The sequences of the ingredients described in the preparation of the dough are preferably to be introduced in the order indicated, constituting the procedure for the manufacture of food products, as well as the times and temperatures of preparation and cooking.

### EXAMPLE 1

A first example of embodiment provides a dough for preparing cookies or sweet baked products. In particular, a particularly advantageous dough for the preparation of cookies or sweet bakery products comprises any amino acid mixture described in the above paragraphs (for example Mixture A, which includes only essential amino acids, or Mixture B, which includes essential amino acids) and non-essential amino acids, or a combination of mixture A and B) for a quantity between 40 and 80 g, or between 40 and g per 1000 g of mixture, optionally admixed with thiamine and pyridoxine in quantities of respectively 10 mg per 100 g of dough, to which one or more of the components selected from the following list are added:
flour (wheat type “0” or “00”, or wholemeal or semi-wholemeal) 650 g,
dietary and/or wheat fiber 55 g/1000 g of dough,
egg yolks 150 grams,
butter 500 g per 1000 g of dough, or oil of various seeds or olive oil, or palm oil 333 g/1000 g of dough,
sugar 270 g/1000 grams of mixture, or mixture of fructose and erythritol 270 g/1000 grams of dough, or agave syrup 200 g/1000 grams of dough, or honey, 90 g/1000 grams of dough, or sweeteners, maltitol, in the same amount of sugar, or glucose syrup in the same quantity of sugar, or malt extract 30 g/1000 g of dough,
vanilla 1.5 g/1000 g of dough,
possibly, 125/1000 g dark chocolate nuggets,
raising agents 70 g/1000 grams of dough.

A method of preparing the dough to obtain cookies or sweet baked goods includes the following steps, carried out in the indicated order:

a) working the chicken eggs in a kneader, preferably for 7-10 minutes, with sugar and a mixture of amino acids according to the present invention, preferably admixed with thiamine and pyridoxine respectively in quantities of 10 g per 100 g of dough;
b) adding an oil or fat selected from the list of components previously listed, and preferably plastic butter at a temperature between 8 and 21° C.;
c) adding flour and dietary fiber at the same time;
d) adding flavoring and any leavening agents;
e) mixing the dough until a smooth, compact and homogeneous mixture is obtained, preferably for a time of between 7 and 9 minutes and at a temperature of between 23 and 26° C.

Subsequently, it is possible to provide a step of refrigeration of the dough in vacuum bags.

Finally, for making cookies and/or desserts, once the forming or casting has been carried out, the baking in the oven takes place in a temperature range of between 180 and 240° C. according to the dough volumes and the cookie size, preferably 14 minutes.

### EXAMPLE 2

A second embodiment example provides a dough intended for the preparation of bread, focaccia, pizza, loaf bread, pan focaccia, piadina, rusks. In particular, a particularly advantageous dough for the preparation of bread, buns, pizza, loaf bread, focaccia bread, piadina, rusks comprises any amino acid mixture described above (for example Mixture A, which includes only essential amino acids, or Mixture B, which includes essential amino acids) and non-essential amino acids, or a combination of mixture A and B) for a quantity between 40 and 60 g per 1000 g of mixture, optionally admixed with thiamine and pyridoxine in quantities of respectively 10 mg per 100 g of dough, and to which the components selected from the following list are added:

for the dough for the preparation of bread: flour (wheat type “0” or “00”, or wholemeal or semi-wholemeal) 1000 g, fresh or starter or chemical yeast 25 g, dietary and/or wheat fiber 120-150 g, fine iodized sea salt 25 g, aromatic herbs 1.5 g, extra virgin olive oil, possibly fat and edible oils with release of essential oils of aromatic herbs 25 g, natural water 550 ml (minimally mineralized, or low mineral content, mineral, medium mineral or hypermineral);
for the dough for the preparation of focaccia/focaccia bread: wholemeal flour 200 g, flour “00” 600 g, flour “0” 200 g, dietary fiber 150-200 g, brewers yeast 30 g, water 500 g, extra virgin olive oil (EVO) 40 g, cherry tomatoes 250 g, oregano 3 g, fine salt 20 g, pitted green olives 150 g;
for the dough for pizza preparation: flour “00” 600 g, water 1000 g, dietary fiber 150-200 g, brewers yeast 4 g, EVO oil 50 g, salt, 5 g;
for the dough for the preparation of rusks: flour “00” 500 g, dietary fiber 150-200 g, whole eggs 100 g, egg yolks 27.5 g, partially skimmed milk 125 g, water 50 g, butter 150 g, brewers yeast 15 g, sugar 20 g, fine salt 20 g;
for the dough for the preparation of piadina: flour “00” 500 g, dietary fiber 150-200 g, lard 80 g, whole milk 150 g, water 150 g, Na bicarbonate 2 g, fine salt 10 g.

Preferably, aromatic herbs means one or more of the following aromatic herbs: laurel, dill, basil, caper, chervil, chives, privet, marjoram, lemon balm, mint, oregano, chilli, parsley, rosemary, sage, savory, shallot, preferably and globally in an amount of about 1-2 grams per 1000 g of dough, even more preferably in an amount of 1.5 grams per 1000 grams of dough.

A method of preparation of the dough to obtain bread, focaccia, pizza, loaf bread, pan focaccia, piadina, rusks includes the following steps, carried out in the indicated order:

a2) mixing dietary fiber (for example any edible food/dietary fiber, soluble or insoluble) and a mixture of amino acids according to the present invention described above, optionally admixed with thiamine and pyridoxine in quantities of respectively 10 g per 100 g of dough;
b2) combining the mixture obtained in step a2) with a selected flour;
c2) adding yeast, water, salt and extra virgin olive oil, preferably mixing for a time of between 11 and 18 minutes, at a preferred temperature of between 23 and 25° C.

To obtain the baked product, the dough is then cooked, for example in the oven.

### EXAMPLE 3

A third example of embodiment provides a mixture intended for the preparation of crepes. In particular, a particularly advantageous dough for the preparation of crepes comprises any mixture of amino acids as described so far (for example Mixture A, which comprises only essential amino acids, or Mixture B, which comprises essential amino acids and non-essential amino acids, or a combination of mixture A and B) in an amount comprised between 40 and 60 grams per 1000 grams of dough, preferably admixed with thiamine and pyridoxine respectively 10 mg per 100 grams of dough, and to which are added: flour (wheat type “0” or “00”, or wholemeal or semi-wholemeal) 250 or 300 g, dietary fiber 40-50 g, cow's milk, goat's milk, sheep's milk, woman's milk, rice or soybean 1000 g, eight eggs of hen, iodized sea salt 1 g, extra virgin olive oil 5 g.

A method of preparing the dough to obtain crepes includes the following steps:

a3) blending eggs, milk, a mixture of amino acids according to the present invention, natural water, dietary fiber, flour or semolina, preferably mixing the liquid product for 5 minutes at a temperature between 18 and 22° C.

### EXAMPLE 4

A fourth example of embodiment provides a dough for the preparation of fresh and/or extruded pasta. In particular, a particularly advantageous dough for the preparation of fresh and/or extruded pasta comprises any mixture of amino acids as described so far (for example Mixture A, which comprises only essential amino acids, or

Mixture B, which comprises essential amino acids and non-essential amino acids, or a combination of mixture A and B) in an amount comprised between 40 and 60 grams per 1000 grams of dough, preferably admixed with thiamine and pyridoxine respectively in amounts of 10 mg per 100 grams of dough, and to which the components of the following list are added: flour (wheat type “0” or “00”, or wholemeal or semi-wholemeal) or durum wheat semolina 250 g, dietary food and/or wheat fiber 50 g, EVO oil or Butter 5-10 g, hen's eggs 100 g, natural water (minimally mineralized, or low mineral, mineral, medium mineral or hypermineral) 100 g.

A method of preparing the dough to obtain fresh, and/or extruded, and/or laminated pasta includes the following steps:

a4) blend eggs, a mixture of amino acids according to the present invention described above or in the continuation of the present invention, and possibly thiamine and pyridoxine in an amount of 10 g per 100 g of dough, water, dietary fiber, flour or semolina, preferably for a time of between 7 and 10 minutes and at a temperature of between 18 and 22° C.

### EXAMPLE 5

A fifth example of embodiment provides a dough for the preparation of potato and/or semolina gnocchi. In particular, a particularly advantageous dough for the preparation of potato and/or semolina dumplings comprises any amino acid mixture described above (for example Mixture A, which includes only essential amino acids, or Mixture B, which includes essential amino acids) and non-essential amino acids, or a combination of mixture A and B) in a quantity between 40 and 60 g per 1000 g of dough, preferably admixed with thiamine and pyridoxine respectively 10 mg per 100 g of dough, and to which the components selected from the following list are added:
for the dough for the preparation of potato dumplings: flour (wheat type “0” or “00”, or wholemeal or semi-wholemeal) 300 g, potato flour, other flour, white potatoes or vitelotte, or in a mixed way, durum wheat semolina 1000 g, dietary and/or wheat fiber 70 g, EVO oil 5-10 g, whole hen's eggs 60 g, Parmigiano reggiano 100 g, fine iodized sea salt 10 g, spices and/or aromatic herbs 1.5-2 g, sugar 5 g;
for the dough for the preparation of semolina dumplings: semi-skimmed milk 1000 g, semolina 175-200 g, dietary fiber 40 g, butter 30 g, egg yolks 50 g, Parmigiano Reggiano 30 g, bacon 150 g, salt to 5 g, nutmeg 0.2 g.

A method of preparing the dough to obtain potato and/or semolina gnocchi includes the following steps:

a5) adding to the base of potatoes and/or semolina, vegetable fiber mixed with a mixture of amino acids according to the present invention, and preferably thiamine and pyridoxine in an amount of 10 g each for every 100 g of dough;
b5) add salt, eggs, spices and water, dietary fiber, flour (in the case of potato dumplings) and preferably knead for a time between 11 and 15 minutes, at a temperature between 18 and 23° C.

### EXAMPLE 6

A sixth embodiment provides a versatile dough, which can be used for making or replacing certain foods. In particular, a particularly advantageous embodiment for the preparation of the versatile dough comprises any amino acid mixture described above (for example Mixture A, which includes only essential amino acids, or Mixture B, which includes essential amino acids) and non-essential amino acids, or a combination of mixture A and B) in a quantity between 40 and 60 g per 1000 g of dough, preferably admixed with thiamine and pyridoxine respectively 10 mg per 100 g of dough, and to which the components selected from the following list are added: dietary and/or wheat fiber in a quantity between 50-100 g, a fat 10-50 g or a food oil 5-10 g, aromatic herbs and spices in a quantity between 1 and 2 g per 1000 g of dough. In this case, dietary fibers can play the role of substitute for eggs.

Preferably, the spices are selected from the group comprising anise, coriander, cumin, wild fennel, juniper, pepper, mustard, thyme, saffron.

A method of preparation of the versatile dough includes the following steps:

a6) dry-mix a mixture of amino acids according to the present invention, optionally admixed with thiamine and pyridoxine respectively in amounts of 10 g per 100 g of dough, the dietary/food and/or wheat fibers, the fat or edible oil; aromatic herbs and/or spices.

The versatile dough can be used to replace eggs or starches in making stuffing, or for making egg-based recipes like omelettes, souffles and pies. Further, the versatile dough can be used to enrich sauces and condiments such as meat sauce, bechamel, or sauces or for the preparation of cannelloni, lasagna, pastries and rice timbales.

In addition, preferably, the versatile dough can be mixed with vegetable creams, minestrone, passed in such a way as to “bind” the aforementioned preparations avoiding starches and fatty substances and to simultaneously improve their nutritional value.

Further examples and methods for making mixes according to the present invention are detailed below, with particular reference to mixes suitable for producing gluten-free and/or lactose-free foods.

### EXAMPLE 7

A seventh example of embodiment provides a dough for the preparation of cookies or sweet baked products without gluten and/or lactose. In particular, a particularly advantageous embodiment for the preparation of biscuits or sweet bakery products without gluten and/or lactose comprises any amino acid mixture described above (for example Mixture A, which includes only essential amino acids, or Mixture B, which includes essential amino acids) and non-essential amino acids, or a combination of mixture A and B) in a quantity between 40 and 60 g per 1000 g of dough, preferably admixed with thiamine and pyridoxine respectively 10 mg per 100 g of dough, and to which one or more of the components selected from the following list are added: rice flour, cornstarch, rice starch, tapioca starch, tapioca, potato starch, pea powder (flour), teff flour, quinoa flour, soy flour, buckwheat flour, or in any case naturally gluten-free flours, in quantities between 800 and 1000 g, naturally gluten-free dietary fiber 7-50 g, thickeners and stabilizers allowed 7-10 g, chicken eggs, 150 g, butter or non-hydrogenated margarine for intolerance to lactose 270 g, sugar 270 g, mixture of fructose and erythritol 270 g, agave syrup 200 g, honey 90 g, or sweeteners, maltitol, glucose syrup 270 g, malt extract 30 g, various seed oil, or olive oil, or extra virgin olive oil 160-180 g, vanilla 1.5 g, dark chocolate nuggets 125 g, raising agents 7 g/100 g.

A method of preparing the dough to obtain cookies or sweet baked goods without gluten and/or lactose includes the following steps:

a7) working the chicken eggs in a kneading machine with sugar and a mixture of amino acids according to the present invention, optionally admixed with thiamine and pyridoxine in quantities of respectively 10 grams per 100 grams of dough;
b7) adding butter or fat selected from the list of components previously listed, and preferably plastic butter at a temperature preferably of between 15 and 18° C.;
c7) simultaneously adding flour and/or a starch and dietary fiber, gluten-free;
d7) adding flavoring and leavening agents;
e7) mixing the dough, preferably for a time between 13 and 15 minutes, until a smooth, compact and homogeneous mixture is obtained.

Subsequently, it is possible to provide a step of refrigeration of the dough in vacuum bags.

Finally, for making cookies and/or desserts, once the forming or casting has been carried out, the baking in the oven takes place in a temperature range of between 180° and 240 ° C. according to the dough volume and size.

### EXAMPLE 8

An eighth embodiment example provides a dough intended for the preparation of bread, focaccia, pizza, loaf bread, pan focaccia, piadina, biscuits without gluten and/or lactose.

In particular, a particularly advantageous embodiment for the preparation of bread, focaccia, pizza, loaf bread, focaccia bread, piadina, rusks without gluten and/or lactose comprises any amino acid mixture described above (for example Mixture A, which includes only essential amino acids, or Mixture B, which includes essential amino acids) and non-essential amino acids, or a combination of mixture A and B) in a quantity between 40 and 60 g per 1000 g of dough, preferably admixed with thiamine and pyridoxine respectively 10 mg per 100 g of dough, and to which one or more of the components selected from the following list are added: rice flour, corn or cornstarch starch, rice starch, tapioca starch, tapioca, potato starch, pea powder (flour), teff flour, quinoa flour, soy flour, buckwheat flour, or in any case naturally gluten-free flours 1000 g, fresh or starter or chemical yeast 25 g, gluten-free food/dietary fiber 7-10 g, fine iodized sea salt 25 g, aromatic herbs 1.5 g, EVO oil or edible oils and fats with transfer of essential oils of aromatic herbs 25 g, natural water 550 ml (minimally mineralized, or mineral, medium mineral or hypermineral).

In particular, for the preparation of focaccia/pan focaccia, the following ingredients are preferably added to the amino acid mixture: gluten-free and naturally gluten-free flour 1000 g, brewer's yeast 30 g, water 500 g, gluten-free food/dietary fiber 7-10 g, EVO oil 40 g, Cherry tomatoes 250 g, Oregano 3 g, fine salt, 20 g, Pitted green olives 150 g.

In particular, for the preparation of pizza, the following ingredients are preferably added to the amino acid mixture: Flour “00” 600 g, Water 1000 g, Brewer's yeast 4 g, Gluten-free food/dietary fiber 7-10 g, EVO oil 50 g, Fine salt, 5 g.

In particular, for the preparation of rusks, the following ingredients are preferably added to the amino acid mixture: whipped flour 500 g, whole eggs 100 g, egg yolks 27.5 g, semi-skimmed milk 125 g, water 50 g, dietary food/gluten-free fiber 7-10 g, butter 150 g, yeast 15 g, sugar 20 g, fine salt 20 g.

In particular, for the preparation of a piadina, the following ingredients are preferably added to the amino acid mixture: 500 g flour, 80 g lard, 150 g whole milk, 150 g water, gluten-free dietary fiber 7-10 g, Na bicarbonate 2 g, fine salt 10 g.

Preferably, by aromatic herbs it is meat one or more of the following aromatic herbs: bay leaf, dill, basil, caper, chervil, chives, privet, marjoram, lemon balm, mint, oregano, chilli pepper, parsley, rosemary, sage, savory, shallot, for 1.5 g each 1000 g of dough.

A method of preparation of the dough to obtain bread, focaccia, pizza, loaf bread, focaccia bread, gluten-free and/or lactose-free cookies includes the following steps:

a8) working gluten-free food/dietary fiber and a mixture of amino acids according to the present invention, optionally admixed with thiamine or pyridoxine in an amount of 10 g each for every 100 g of dough;
b8) combining the mixture obtained in step a8) with a flour and/or starch selected from the previous list;
c8) adding yeast (in one of the types of yeast: dry, compressed, fresh, beer, chemical or starter yeast), water, salt and extra virgin olive oil.

The dough working time, in this case, is preferably between 13 and 18 minutes and the baking temperature is between 180° and 240° C.

### EXAMPLE 9

A ninth example of embodiment provides a dough for the preparation of gluten-free and/or lactose-free crepes. In particular, a particularly advantageous embodiment for the preparation of gluten-free and/or lactose-free crepes comprises any mixture of amino acids as described so far (for example Mixture A, which comprises only essential amino acids, or Mixture B, which comprises essential amino acids and non-essential amino acids, or a combination of mixture A and B) in an amount comprised between 40 and 60 grams per 1000 grams of dough, preferably admixed with thiamine and pyridoxine respectively in a quantity of 10 mg per 100 grams of dough, and to which are added one or more of the components selected from the following list: rice flour, corn starch or cornstarch, rice starch, tapioca starch, tapioca, potato starch, pea powder (flour), teff flour, quinoa flour, soy flour, buckwheat flour, or in any case naturally gluten-free flour 250 or 300 g, cow's, goat's, sheep's, woman's, rice or soy milk 400-500 g, eight chicken eggs, gluten-free food/dietary fiber 7-10 g, iodized sea salt 1 g, extra virgin olive oil 10 g.

A method of preparing the dough to obtain gluten-free and/or lactose-free crepes includes the following steps:

a9) blending eggs, milk, a mixture of amino acids according to the present invention, optionally admixed with thiamine and pyridoxine in an amount respectively of 10 grams per 100 grams of dough, natural water, gluten-free dietary fiber, flour selected from the previous list of ingredients.

Preferably, the mixing timing is between 1 and 18 minutes.

### EXAMPLE 10

A tenth example of embodiment provides a dough for the preparation of pasta, fresh and/or extruded gluten-free and/or lactose-free. In particular, a particularly advantageous embodiment for the preparation of gluten-free and/or lactose-free pasta, fresh and/or extruded comprises any mixture of amino acids as described so far (for example Mixture A, which comprises only essential amino acids, or Mixture B, which comprises essential amino acids and non-essential amino acids, or a combination of mixture A and B) in an amount comprised between 40 and 60 grams per 1000 grams of dough, preferably admixed with thiamine and pyridoxine respectively in a quantity of 10 mg per 100 grams of dough, and to which are added one or more of the components selected from the following list: rice flour, corn starch or cornstarch, rice starch, tapioca starch, tapioca, potato starch, pea powder (flour), teff flour, quinoa flour, soy flour, buckwheat flour, or in any case naturally gluten-free flour 250 g, food/dietary fiber naturally gluten-free 7-10 g, EVO oil 5-10 g, thickeners and stabilizers 7-10 g, hen's eggs 100 g, natural water (minimally mineralized, or low mineral content, mineral, medium mineral or hypermineral) 80-100 g.

A method of preparation of the dough to obtain gluten-free and/or lactose-free pasta, fresh and/or extruded comprises the following steps:

a10) blending eggs, a mixture of amino acids according to the present invention, optionally admixed with thiamine and pyridoxine in an amount respectively of 10 grams per 100 grams of dough, water, naturally gluten-free food/dietary fiber, flour selected from the previous list of ingredients.

Preferably, the mixing timing is between 13 and 18 minutes.

### EXAMPLE 11

An eleventh example of embodiment provides a dough for the preparation of potato gnocchi without gluten and/or lactose.

In particular, a particularly advantageous embodiment for the preparation of gluten-free and/or lactose-free potato dumplings comprises any mixture of amino acids as described so far (for example Mixture A, which comprises only essential amino acids, or Mixture B, which comprises essential amino acids and non-essential amino acids, or a combination of mixture A and B) in an amount comprised between 40 and 60 grams per 1000 grams of dough, preferably admixed with thiamine and pyridoxine respectively in a quantity of 10 mg per 100 grams of dough, and to which are added one or more of the components selected from the following list: white potatoes or vitelotte, potato semolina, other flours, or other gluten-free flours 1000 g, whipped flour 300 g, food/dietary fibers without gluten 70 g, EVO oil 10-15 g, whole chicken eggs 60 g, parmigiano reggiano 100 g, fine iodized sea salt 10 g, spices and/or aromatic herbs 1.5 g, natural water (minimally mineralized, or low mineral, mineral, medium mineral or hypermineral), sugar 5 g.

Moreover, a particularly advantageous embodiment for the preparation of gluten-free potato dumplings comprises any amino acid mixture described above (for example Mixture A, which includes only essential amino acids, or Mixture B, which includes essential amino acids) and non-essential amino acids, or a combination of mixture A and B) in a quantity between 40 and 60 g per 1000 g of dough, preferably admixed with thiamine and pyridoxine respectively 10 mg per 100 g of dough, and to which one or more of the components selected from the following list are added: semi-skimmed HD milk without lactose 1000 g, gluten-free flour 175 g, gluten-free dietary fiber 40 g, butter 30 g, egg yolks 50 g, parmigiano reggiano 30 g, bacon 150 g, fine salt 5 g, nutmeg 0.2 g, aromatic herbs.

A method of preparing the dough to obtain gluten-free and/or lactose-free potato gnocchi includes the following steps:
a11) combining the potato base, gluten-free food/dietetic fiber mixed with a mixture of amino acids according to the present invention, optionally admixed with thiamine and pyridoxine in quantities of respectively 10 grams per 100 grams of dough;
   b11) adding salt, eggs, spices and water, a flour selected from the previous list of ingredients.

Preferably, the mixing time is between 13 and 18 minutes and the cooking temperature is 100° C.

### EXAMPLE 12

A further example of embodiment provides for the realization of a cookie. In this embodiment, the production method involves foaming the egg component using only 50% of the amount of sugar provided for the total mixture, i.e. about 135 g, performing this procedure in a bain-marie with a temperature strictly maintained between 50 and 55° C.; the foaming and adjustment times of the mixture at the pre-set temperature induce modifications in the protein components able to better amalgamate, protect and stabilize the amino acid component with the remaining ingredients, favoring a better and more uniform gilding of the product.

Moreover, in a preferred embodiment of the invention for the production of bakery products (cakes, biscuits of various kinds, bi-toasted), it is contemplated to dough protein components derived from eggs, with percentage variations related and secondary to the quantity of amino acids, at the density and softness of the dough, for example with a process similar to that indicated in example 12 for the preparation of the cookie.

Preferably, the mixing times are between 13 and 18 minutes and the baking temperature of the biscuit is between 180° and 240° C.

### EXAMPLE 13

In the case of bakery products, it was necessary to change the ingredients and techniques. In fact this type of products provides aggregations of ingredients (with the exception of very rare cases) of butter and eggs, using the fibers as a substitute. In this embodiment, the dough includes food/dietary fiber with or without gluten, including flours obtained from legumes. In the case of the addition of edible oils, such as extra virgin olive oil, preferably the method involves subjecting the oil to vacuum techniques, i.e. steaming or immersing in a vacuum-sealed bag at a temperature of between 45° and 65° C., possibly and preferably with the addition of aromatic herbs or with the addition of spices treated with the vaporization and blast chilling technique, which allows the sanitization and transfer of the aromas.

This procedure determines a reduction of unpleasant flavors and of the amino acid aftertaste. The techniques described above contribute to the elimination of unpleasant flavors, even without the need for use of aromas in the mixture.

Preferably, moreover, for the realization of the fortified gastronomic composite food, the method comprises a mixing time of 13 to 18 minutes and a cooking step, in which the cooking temperature is between 145° and 190°, or between 150° and 240°, for 20-30 minutes in relation to the volumes of dough and the thickness of the food before cooking.

Innovatively, the present invention relates to a dough which allows to introduce the intake of essential amino acids in the daily food routine of an individual, for example in the form of pastes, breads, focaccia or bakery products.

In particular, the preparation of a dough made predominantly or essentially by a synergistic interaction of dietary fibers, at least a fat or edible oil and at least one egg, as well as at least an essential amino acid and at least one non-essential amino acid or a conditionally essential amino acid, allows a food to be obtained without the annoying bitter taste of amino acids and, at the same time, favors a non-medicalized administration of amino acids. Furthermore, in doughs that do not require the use of eggs, masking of the bitter taste is in any case obtained thanks to the dosage of dietary fibers and edible fat or oil.

Furthermore, the combined use of the aforementioned ingredients favors the bioavailability of the amino acids.

Moreover, surprisingly, the sequence of steps of the method of making the dough, as described and performed in the precise order indicated, further allows improving the masking of the bitter taste of the amino acids present in the dough.

This favors the intake of amino acids in a prolonged time consistent with the expected effect of protection of muscle masses both in the elderly and in the subject subjected to metabolic stress (or in any case physiological or paraphysiological situations with a high need for amino acids). The administration of amino acids in chronic, in the form of foods that are pleasing in terms of taste and gastronomy (and, in fact, not distinguishable as flavor and aroma from common foods without added amino acids), it is a novelty in a world food panorama dominated by high-protein foods, which have the disadvantages already listed. The direct intake of amino acids allows the desired effects of food protection and supplementation to be achieved more quickly and more safely and effectively.

Therefore, the administration of amino acids not through “medicalized” products (tablets, sachets, solutions, etc.), but with common food products for daily use, allows the chronic administration of an adequate amount of amino acid aimed at preserving the muscle mass of large sections of the population with increased needs (from the elderly, to the growing subjects, to athletes, or subjects that for various diseases must counter the predictable loss of lean mass due to sarcopenia-causing and/or cachetizing diseases).

Furthermore, the fortification of foodstuffs of common and daily use with essential and non-essential or conditionally essential amino acids, is an element of undoubted advantage for the nutrition of the population in endemically poor countries in the feeding of animal proteins.

One embodiment of the dough which involves the use of an amino acid mixture comprising 23 amino acids, between essential and non-essential amino acids (or non-essential conditional), selected and assembled in consideration of their bioactive and nutritional characteristics has proved particularly effective.

In this advantageous embodiment example, the dough according to the present invention has been used for cooking a biscuit, subsequently administered to a sample of selected subjects. An experimentation was then carried out aimed at demonstrating the full bioavailability of the amino acids contained in the biscuit, with a final product characterized by excellent palatability (absence of the bitter taste characteristic of the amino acid mixture, fragrance, softness, easy chewiness, etc.). In this specific embodiment, the dough contained a mixture of essential amino acids, present in a ratio of 8 g/100 g of final product. In particular, the dough comprised L-Leucine, L-Isoleucine, L-Valine, L-Lysine, L-Threonine, L-Histidine, L-Phenylalanine, L-Methionine, L-Tryptophan, Cysteine, Arginine, Citrulline, Ornithine, Glutamine, Glycine, Serine, Proline, Tyrosine, Taurine, Alanine, Asparagine, Aspartic acid, Glutamic acid.

Advantageously, the amino acid content according to the present invention allows effective nutritional effects (both therapeutic and preventive) to be obtained, without incurring the typical side effects of protein intake. For example, a quantity of 8 grams of amino acids in 100 grams of total dough is equivalent to a share of 50 grams of absorbed net proteins (for example 4 biscuits), but without a corresponding nitrogenous load, contraindicated in the elderly.

Moreover, advantageously, the amino acid composition comprising essential and non-essential amino acids, each with different trophic action on organs and tissues, allows to cover a wide range of pathologies and nutritional needs, in each age group, and in any condition, acute or chronic.

Furthermore, advantageously, the variety of mixes according to the present invention covers most of the products based on flour present in the food, such as pastes, biscuits, bitosted, up to the pastry, with and without gluten, ensuring a coverage of all the possibilities and daily feeding needs. Moreover, the intake of amino acids in daily diet allows the drug-nutritional properties of amino acids to be developed to the maximum and without any commitment for the subject.

With the present invention, it is possible to reintegrate for a suitable period and in a non-medicalized way the quantity of amino acids necessary to obtain a desired nutritional effect, counteracting the negative effects of the deficiency.

Moreover, the present invention, used on a large scale, such as for example in population nutrition with food fortification, allows to prevent amino acid deficiencies on a large number of subjects, bringing both social and economic benefits, considering the many chronic and acute pathologies that would benefit from an adequate amino acid intake and the consequent reduction of social networks costs linked to assistance for these diseases.

To date, there is no commercially available mix in the form of sachets or tablets, capable of administering a wide variety of amino acids, for example as many as 23, variously combined and assembled so as to meet the needs of a person at nutritional risk in any age of life, both for an increased need (childhood, adolescence, pregnancy, adulthood) in particular conditions of biological or health stress, or advanced age for a para-physiological decay of nutrient absorption capacities, for a pathologically reduced intake (aging anorexia, acute and chronic diseases, acute and chronic defeating diseases, neoplasms). To administer a mix similar in variety and quantity, infusions of parenteral infusion mixtures should be used.

Moreover, advantageously, the possibility of introducing large quantities of amino acids per 100 g of product is another feature of the originality of the dough, both for bakery products and for bread products. The amino acid requirements in fact, if considered for each single amino acid, are rather high both in health and in disease, with variable needs both in the various ages of life and in various physiological conditions (childhood, adolescence, pregnancy, adulthood, maturity, first and second senescence) and pathological conditions (organ failure, neoplasms, acute critical illnesses both extemporaneous and recurrent, increases in requirements for any reason).

Further, advantageously, the simultaneous presence of essential amino acids and non-essential amino acids, and in particular of non-essential conditional amino acids, allow to obtain a strategic food for health in conditions of metabolic stress or increased demands. The nutritional complexity of the mix therefore gives it a unique and original versatility of use.

It is clear that a man skilled in the art may make changes to the invention described above in order to meet incidental needs, all falling within the scope of protection defined in the following claims.

1-20. (canceled)

21. A method for preparing a fortified gastronomic composite food, the method comprising the following steps carried out in the order listed below:
a) working hen eggs in a kneader with sugar and a mixture of at least one essential amino acid and at least one non-essential amino acid or conditionally essential amino acid;
b) adding edible fat or oil;
c) adding flour and dietary fibers at the same time;
d) adding flavoring and leavening agents;
e) mixing a dough to obtain a smooth, compact and homogeneous dough; and
f) baking the dough obtained from the preceding steps in an oven,
wherein the sum of amounts of flour, dietary fibers, edible fat or oil, and hen eggs, has a weight percentage of at least 50% of the total weight of the smooth, compact and homogeneous dough obtained in step e),
and wherein the weight percentage of the at least one non-essential amino acid or conditionally essential amino acid is at least 4% with respect to the total weight of the dough.

22. The method of claim 21, wherein step a) is carried out for a time comprised between 7 and 10 minutes.

23. The method of claim 21, wherein step a) further comprises adding thiamine and pyridoxine in an amount of 10 g per 100 g of dough, respectively.

24. The method of claim 21, wherein step e) is carried out for a time comprised between 7 and 9 minutes and at a temperature ranging from 23° C. to 26° C.

25. A dough for making a gastronomic composite food, the dough comprising cereal flour, dietary fibers, at least one edible fat or oil, at least one egg, at least one essential amino acid and at least one non-essential amino acid or conditionally essential amino acid,
wherein said at least one essential amino acid and at least one non-essential amino acid or conditionally essential amino acid is added to the dough in isolated form,
wherein the sum of amounts of cereal flour, dietary fibers, at least one edible fat or oil, and at least one egg, has a weight percentage of at least 50% of the total weight of the dough and wherein the weight percentage of the at least one non-essential amino acid or conditionally essential amino acid is at least 4% with respect to the total weight of the dough,
wherein said dough comprises between 0.1% and 15% inclusive by weight respectively of L-threonine and/or L-cysteine and/or L-histidine and/or L-phenylalanine and/or L-methionine and/or L-tyrosine and/or L-tryptophan,
and wherein said at least one non-essential amino acid is selected from the group consisting of alanine, aspartic acid, asparagine, and glutamic acid.

26. The dough of claim 25, wherein the sum of amounts of cereal flour, dietary fibers, at least one edible fat or oil, and at least one egg, has a weight percentage of at least 70% of the total weight of the dough.

27. The dough of claim 25, wherein the dietary fibers are one or more dietary fibers selected from the group consisting of: acacia, bamboo, guar, apple, and polysaccharide compounds of non-starchy origin.

28. The dough of claim 25, wherein the dietary fibers are one or more dietary fibers selected from the group consisting of: lignin, cellulose, hemicellulose, beta-glucans, inulin, oligofructose, fructooligosaccharides, pectin, glucomannan, polydextrose, polyols, resistant dextrins, resistant starch, phenolic esters, cutin, gums, mucilage, and combinations thereof

29. The dough of claim 25, further comprising thiamine and/or pyridoxine.

30. The dough of claim 25, wherein essential amino acids include L-leucine, L-lysine, L-isoleucine, L-valine, L-threonine, L-histidine, L-phenylalanine, L-methionine, L-tyrosine, and L-tryptophan in a total amount of between 40 g and 60 g per 1000 g of dough, admixed with thiamine and pyridoxine in an amount of 10 mg per 100 g of dough, respectively.

31. The dough of claim 25 comprising dietary fibers in a percentage between or equal to 2% and 15% by weight relative to the total weight of the dough.

32. The dough of claim 25, comprising wheat flour, dietary fibers, eggs, and butter, the sum of which has a weight percentage of at least 50% of the total weight of the dough and one or more of the following components: granulated sugar, fructose and erythritol mixture, agave syrup, honey, sweeteners, maltitol, glucose syrup, malt extract, seed oil, olive oil, extra virgin olive oil, palm oil, vanilla, dark chocolate, and leavening agents.

23. The dough of claim 25, further comprising added medium-chain triglycerides.

34. The dough of claim 25, comprising L-Leucine, L-Isoleucine, L-Valine, L-Lysine, L-Threonine, L-Histidine, L-Phenylalanine, L-Methionine, L-Tryptophan, Cysteine, Arginine, Citrulline, Ornithine, Glutamine, Glycine, Serine, Proline, Tyrosine, Taurine, Alanine, Asparagine, Aspartic acid, and Glutamic acid.

35. A fortified gastronomic composite food, made using a mixture of ingredients comprising a dough according to claim 25.

36. A pastry product or a baked product obtained from a dough according to claim 25.
